(19) United States
(12) Patent Application Publication
(10) Pub. No.: US 2014/0293022 A1
(43) Pub. Date: Oct. 2, 2014

(54) INFORMATION PROCESSING APPARATUS, INFORMATION PROCESSING METHOD AND RECORDING MEDIUM

(71) Applicants: Sony Corporation, Tokyo (JP); Sony Computer Entertainment Inc., Tokyo (JP)

(72) Inventors: Yoshiki Okamoto, Kanagawa (JP); Masaaki Hara, Tokyo (JP); Satoru Seko, Kanagawa (JP); Masaaki Oka, Kanagawa (JP)

(21) Appl. No.: 14/355,800

(22) PCT Filed: Oct. 15, 2012
(86) PCT No.: PCT/JP2012/076638

§ 371 Date: May 1, 2014

(30) Foreign Application Priority Data
Nov. 10, 2011 (JP) 2011-246220

(51) Int. Cl. H04N 13/04

(52) U.S. Cl. CPC H04N 13/04; H04N 2213/00
USPC 348/51

(57) ABSTRACT

There is provided an information processing apparatus including a display controller that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

### TECHNICAL FIELD

The present disclosure relates to an information processing apparatus, an information processing method, and a recording medium.

### BACKGROUND ART

In recent years, with the development of science and technology, stereoscopic image display apparatuses causing human eyes to factitiously recognize a 3D object by using only a convergence function of human eyes and using a flat panel display are increasingly provided (see, for example, Patent Literature 1 below).

In the fields such as science and technology, medical science, industry, architecture, and design, it is very useful to three-dimensionally display an object based on 3D data by using the technology as described above while interactively changing the position, angle, and size thereof

### CITATION LIST

### Patent Literature

Patent Literature 1: JP 2005-128897A

### SUMMARY OF INVENTION

### Technical Problem

In the stereoscopic image display apparatus as shown in Patent Literature 1, however, human eyes are caused to factitiously recognize a 3D object by using only the convergence function of human eyes and thus, an allowable range (fusional area) lies in an area where the focus function (adjustment function) and the convergence function of eyes diverge and the range in which an observer can have stereoscopic viewing is limited. Therefore, when, for example, the position, size, or angle of an object is interactively changed, an object or a portion thereof beyond the allowable range may be generated, leading to lower quality of the stereoscopic display.

In view of the above circumstances, the present disclosure proposes an information processing apparatus capable of improving the quality of the stereoscopic display, an information processing method, and a recording medium.

### Solution to Problem

According to the present disclosure, there is provided an information processing apparatus including a display controller that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

According to the present disclosure, there is provided an information processing method including controlling a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

According to the present disclosure, there is provided a recording medium having a program stored therein, the program causing a computer to realize a display control function that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

According to the present disclosure, when an object to be displayed is three-dimensionally displayed, the display of an object to be displayed is controlled in such a way that the display format of an object to be displayed positioned outside the fusional area of an observer is different from that of an object to be displayed positioned inside the fusional area.

### Advantageous Effects of Invention

According to the present disclosure described above, the quality of the stereoscopic display can be improved.

### BRIEF DESCRIPTION OF DRAWINGS

FIG. 1 is an explanatory view illustrating a three-dimensional recognition function of a human being.

FIG. 2 is a block diagram showing an exemplary configuration of an information processing apparatus according to a first embodiment of the present disclosure.

FIG. 3 is an explanatory view illustrating display control processing of the information processing apparatus according to the embodiment.

FIG. 4 is an explanatory view illustrating display control processing of the information processing apparatus according to the embodiment.

FIG. 5 is an explanatory view illustrating display control processing of the information processing apparatus according to the embodiment.

FIG. 6 is an explanatory view illustrating display control processing of the information processing apparatus according to the embodiment.

FIG. 7 is a flow chart showing an exemplary flow of an information processing method according to the embodiment.

FIG. 8 is a block diagram showing an exemplary hardware configuration of the information processing apparatus according to an embodiment of the present disclosure.

### DESCRIPTION OF EMBODIMENTS

Hereinafter, preferred embodiment of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be provided in the order shown below.

(1) Three-dimensional Recognition Function of Human Being

(2) First Embodiment

(2-1) Configuration of Information Processing Apparatus

(2-2) Flow of Information Processing Method

(3) Hardware Configuration of Information Processing Apparatus According to an embodiment of the present disclosure

(Three-Dimensional Recognition Function of Human being)

Three-dimensional recognition (distance recognition to an object) of a human being is realized by both of the focus function (adjustment function) and the convergence function of eyes. That is, when a human being observes an object three-dimensionally with both of left and right eyes, the eye movement called a convergence movement is made such that a corresponding point of a right-eye image and that of a left-eye image of the object to be fixed match and the object to be fixed is thereby perceived as a single stereoscopic image.

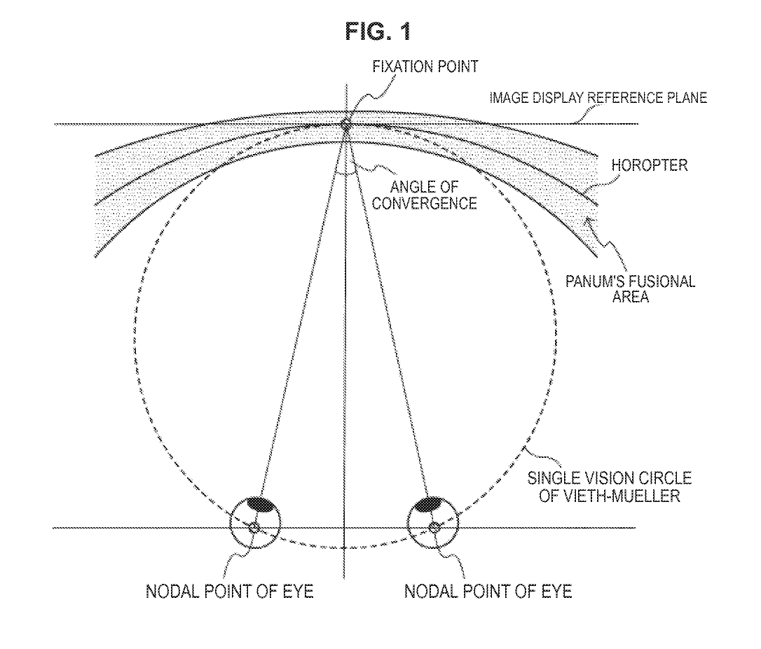

As shown in FIG. 1, the point where a corresponding point of a right-eye image and that of a left-eye image match is called a fixation point and a point on the circumference passing through three points of the fixation point and optical centers (that is, nodal points) of both eyes is a point allowing single vision by both eyes and is called a single vision circle of Vieth-Mueller showing an optical horopter. As shown in FIG. 1, a horopter actually psychophysically measured approximately matches the single vision circle, though the curvature thereof is somewhat smaller than that of the single vision circle.

A point positioned nearer than the fixation point is shifted to the outer side from a corresponding point on the retina and a point positioned farther than the fixation point is shifted to the inner side and the parallax increases with an increasing distance (amount of shifts) thereof. If the binocular parallax is large, an object is recognized as double images, but if the binocular disparity on the retina is minimal, stereognosis is realized. That is, there exists a narrow area before and after the horopter in which, even if a parallax is present between both eyes, sensory fusion is performed without the parallax being perceived as double images. The area is called the Panum's fusional area and stereognosis can be caused in the area by using a small binocular parallax. The binocular parallax is large before and after the Panum's fusional area and a perception as double images is caused and thus, the human being makes the convergence movement and divergence movement to cancel out the perception and brings the fixation point into the fusional area to establish binocular stereoscopic vision.

It is known that, between the adjustment function and the convergence function, a contribution of the convergence function is larger than that of the adjustment function. Thus, in current stereoscopic image display apparatuses using a flat panel display, focusing on such properties, stereognosis is provided to the observer by using only the convergence function of human eyes and by shifting the convergence (parallax) though the focus (adjustment) is adjusted to the display surface.

An object positioned by protruding to the side of the observer from an image display reference plane or an object positioned on the depth side from the image display reference plane has a great divergence between the focus (adjustment) and the convergence of eyes and viewing for a long time is said to tire the eyes or cause a headache in some people.

Therefore, when, for example, the position, size, or angle of an object is interactively changed, an object or a portion thereof beyond the allowable range may be generated, leading to lower quality of the stereoscopic display. Therefore, when the position, size, or angle of an object is interactively changed, if an arbitrary position is used as the origin for display, the place desired to be fixed by the observer may be made difficult for stereoscopic viewing.

As a result of intensive examination of methods capable of relieving the problems as described above and improving the quality of the stereoscopic display, the present inventors hit upon an information processing apparatus and an information processing method as will be described below.

### First Embodiment

### Configuration of Information Processing Apparatus

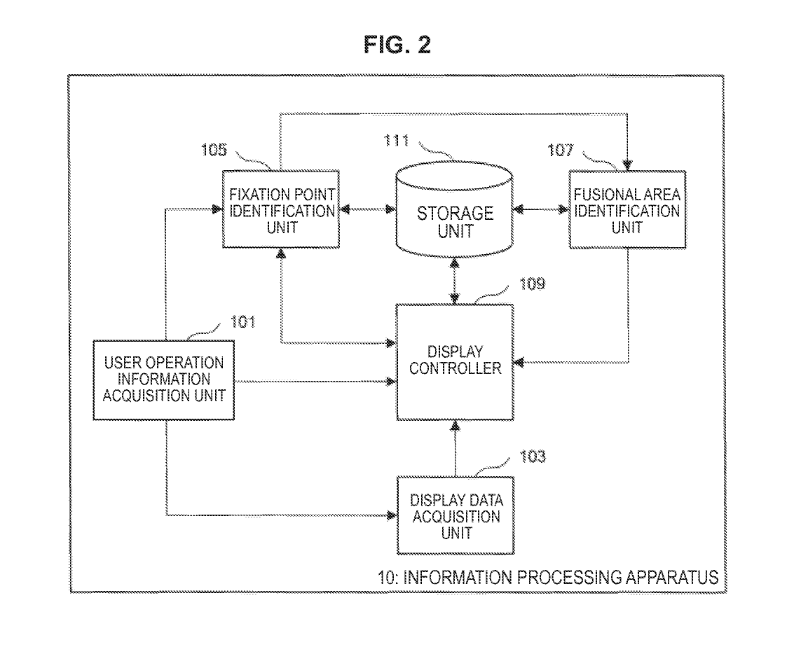

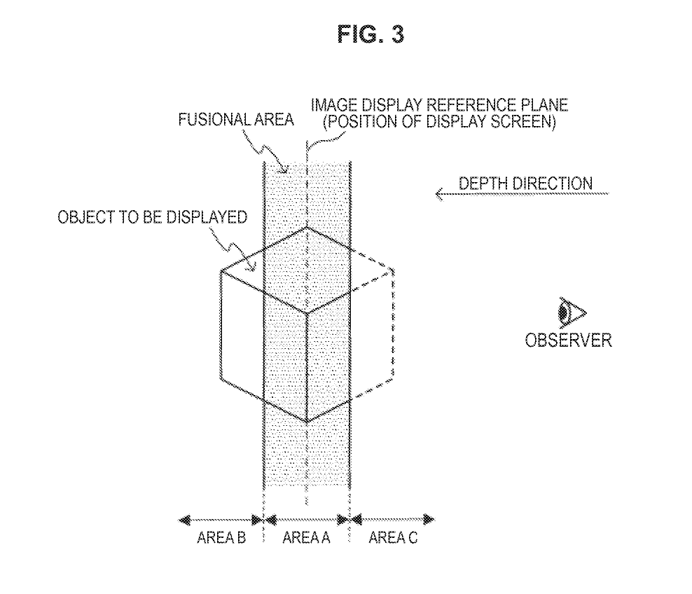

Subsequently, the configuration of an information processing apparatus according to the first embodiment of the present disclosure will be described in detail with reference to FIGS. 2 to 6. FIG. 2 is a block diagram showing an exemplary configuration of an information processing apparatus 10 according to the present embodiment and FIGS. 3 to 6 are explanatory views illustrating display control processing of the information processing apparatus according to the present embodiment.

As shown in FIG. 2, the information processing apparatus 10 according to the present embodiment mainly includes a user operation information acquisition unit 101, a display data acquisition unit 103, a fixation point identification unit 105, a fusional area identification unit 107, a display controller 109, and a storage unit 111.

The user operation information acquisition unit 101 is realized by, for example, a CPU (Central Processing Unit), a ROM (Read Only Memory), a RAM (Random Access Memory), an input device and the like. The user operation information acquisition unit 101 identifies an operation (user operation) performed on the input device such as a mouse, keyboard, touch panel, gesture input device, sight line input device or the like provided in the information processing apparatus 10 to generate user operation information related to the user operation. Then, the user operation information acquisition unit 101 outputs the generated user operation information to the display data acquisition unit 103, the fixation point identification unit 105, the display controller 109 and the like. Accordingly, these processing units can grasp what kind of operation has been performed on the information processing apparatus 10 by the user so that the function corresponding to the user operation can be provided.

The display data acquisition unit 103 is realized by, for example, a CPU, a ROM, a RAM, a communication device and the like. The display data acquisition unit 103 acquires display data specified by the user in accordance with user operation information about the user operation performed on the information processing apparatus 10 by the user and output by the user operation information acquisition unit 101 from the storage unit 111 described later, various kinds of recording media inserted into the information processing apparatus 10, or various computers connected to various networks such as the Internet and with which the information processing apparatus 10 can communicate.

The display data acquired by the display data acquisition unit 103 is 3D image data having information (hereinafter, also called stereoscopic information) representing a three-dimensional shape of an object to be displayed and is data that, when the 3D image data is displayed stereoscopically, allows the observer to stereoscopically observe the shape of the object to be displayed from any viewpoint. Examples of such 3D image data include image data generated by a 3D CAD system, microscope image data generated by a microscope capable of outputting a stereoscopic shape of an object to be observed as image data, image data of a 3D game, and measured data generated when some object is measured in a 3D space. However, display data acquired by the display data acquisition unit 103 is not limited to the above examples.

The display data acquisition unit 103 outputs display data (entity data) of the acquired 3D image data to the display controller 109 described later. The display data acquisition unit 103 may associate the acquired display data with time information about the date/time when the data is acquired before storing the data in the storage unit 111 described later as history information.

The fixation point identification unit 105 is realized by, for example, a CPU, a ROM, a RAM and the like. The fixation point identification unit 105 identifies a point of the object to the displayed written in the stereoscopically displayed image data (in other words, the position of the object to be displayed desired by the user to be observed) in accordance with user operation information output by the user operation information acquisition unit 101 or user captured images obtained by an imaging camera (not shown) or the like provided in the information processing apparatus 10 and handles such a point as a fixation point.

When the observer (the user of the information processing apparatus 10) of 3D image data determines the position of a position specifying object such as a cursor or pointer by operating the user interface on a controller, keyboard, mouse, gesture input device, sight line input device or the like, the operation result is acquired by the user operation information acquisition unit 101 and output to the fixation point identification unit 105. The fixation point identification unit 105 can identify, for example, the position of an object to be displayed (the spatial position in a coordinate system defining a 3D structure of an object to be displayed) decided by the user using a position specifying object as a fixation point on which the user focuses.

The fixation point identification unit 105 may identify the user position by detecting corresponding points from a plurality of images and applying a known method that identifies the position based on the principle of triangulation using user captured images captured by an imaging device (not shown) or the like provided in the information processing apparatus 10 before estimating the position of the fixation point from, for example, the interval between both eyes, the size of the angle of convergence or the like.

The method of identifying the fixation point used by the fixation point identification unit 105 according to the present embodiment is not limited to the above examples and the fixation point can be identified or estimated by using a known method.

When the fixation point in the displayed object to be displayed is identified, the fixation point identification unit 105 outputs information indicating an identification result of the fixation point to the display controller 109 described later. If the fusional area identification unit 107 described later uses information about the fixation point when identifying the fusional area of the observer, the fixation point identification unit 105 may output information indicating an identification result of the fixation point to the fusional area identification unit 107.

The fusional area identification unit 107 is realized by, for example, a CPU, a ROM, a RAM and the like. The fusional area identification unit 107 identifies a fusional area of the observer of an object to be displayed (in other words, the user of the information processing apparatus 10) and outputs the fusional area to the display controller 109.

The fusional area identification unit 107 can refer to, for example, information about the user's fusional area that is preset and stored in the storage unit 111 or the like to identify the state of distribution of the corresponding user's fusional area, the size of the fusional area and the like. The fusional area identification unit 107 may also refer to information about the general user's fusional area that is preset and stored in the storage unit 111 or the like to identify the state of distribution of the user's fusional area, the size of the fusional area and the like. Further, the fusional area identification unit 107 may identify the user's fusional area by causing the user to customize the initial setting value of the preset fusional area.

Information about the general user's fusional area can be obtained by, for example, measuring fusional areas of many users in advance and analyzing measurement results of the fusional areas by known statistical processing. In addition to the above method, the fusional area identification unit 107 can identify the user's fusional area by using any known method.

When the user's fusional area is identified, the fusional area identification unit 107 outputs the obtained identification result to the display controller 109 described later.

If the information processing apparatus 10 according to the present embodiment performs image display processing described later using only information about the general user's fusional area registered in advance, the fusional area identification unit 107 having the aforementioned function may not be contained.

The display controller 109 is realized by, for example, a CPU, a GPU, a ROM, a RAM, an output device, a communication device and the like. The display controller 109 acquires data stored in the storage unit 111 and corresponding to content to be displayed and displays the data on the display screen. When a signal indicating the movement of a position selection object such as a cursor, pointer or the like is transmitted from the input device such as a mouse, keyboard, touch panel, gesture input device, sight line input device or the like included in the information processing apparatus 10, the display controller 109 causes the display screen to display the movement of the position selection object so as to fit to the transmitted signal.

When display data is output by the display data acquisition unit 103, the display controller 109 uses the display data to exercise display control to stereoscopically display an object to be displayed corresponding to the display data. In this case, the display controller 109 performs display control of the display data by using user operation information output by the user operation information acquisition unit 101, information about the fixation point output by the fixation point identification unit 105, and information about the fusional area output by the fusional area identification unit 107.

More specifically, when objects to be displayed by using 3D image data, the display controller 109 controls the display of objects to be displayed such that the display format of an object to be displayed positioned outside the fusional area of the observer is different from that of an object to be displayed positioned inside the fusional area. The control processing of the display format performed by the display controller 109 will be described more concretely below with reference to FIG. 3.

When an object to be displayed is stereoscopically displayed, the display controller 109 according to the present embodiment performs display control by roughly dividing the direction corresponding to the depth direction when viewed by the user (observer) into, as shown in FIG. 3, three areas shown below:

(1) Area containing the image display reference plane (for example, the position of the display screen) serving as a reference when an object to be displayed is stereoscopically displayed and the distance from the image display reference plane is equal to a predetermined distance or less (area A)

(2) Area away from the image display reference plane beyond the predetermined distance in a direction away from the observer (area B)

(3) Area away from the image display reference plane beyond the predetermined distance to the side of the observer (area C)

Among these areas A to C, the area A is an area contained in a fusion range of the observer and the areas B and C are areas outside the fusion range of the observer.

When 3D image data output by the display data acquisition unit 103 is displayed, the display controller 109 exercises display control such that a portion contained in the area A is stereoscopically viewed by attaching the parallax to an object to be displayed contained in the area A by a known method.

An object that will be displayed in the area B will be displayed outside the fusional area for the observer and thus, the display controller 109 exercises display control such that the parallax does not change in the area B by fixing the parallax of an object that will be displayed in the area B to the parallax in the boundary between the area A and the area B. As a result, an object to be displayed in the area B will not be displayed by being projected onto the interface between the area A and the area B and therefore, the observer will not recognize the object to be displayed in the area B as double images.

Also an object that will be displayed in the area C will be displayed outside the fusional area for the observer and thus, the display controller 109 exercises display control such that an object to be displayed contained in the applicable area will not be displayed. Accordingly, an object to be displayed that should originally be displayed in the area C and will be perceived by the observer as double images no longer exists.

When 3D image data is stereoscopically displayed, as described above, the display controller 109 can improve the quality of the stereoscopic display by accommodating an area that is difficult for the observer to stereoscopically view (area B) in an area capable of stereoscopic viewing or preventing the display of such an area (area C) to eliminate factors that could be perceived by the observer as double images.

Particularly when the display controller 109 exercises display control of a display apparatus that realizes a multi-view naked-eye stereoscopic display, it is difficult for the display apparatus to reduce crosstalk between the right and left eyes to zero to realize a more realistic and natural stereoscopic display and the fusional area (effective fusional area) recognized by the observer is considered to be narrow. In such a case, the above display control is extremely useful to improve the quality of the stereoscopic display.

Incidentally, the display controller 109 may exercise display control in such a way that an object to be displayed positioned in at least one of the area B and the area C disappears with an increasing distance from the area A. In addition, the display controller 109 may exercise only one of the display control for the area B and that for the area C to discontinue the other.

In addition to the display control based on the fusional area as described above, the display controller 109 may perform the display control described below.

That is, the display controller 109 may adjust the display position of an object to be displayed so that the fixation point selected by the observer is positioned in the image display reference plane.

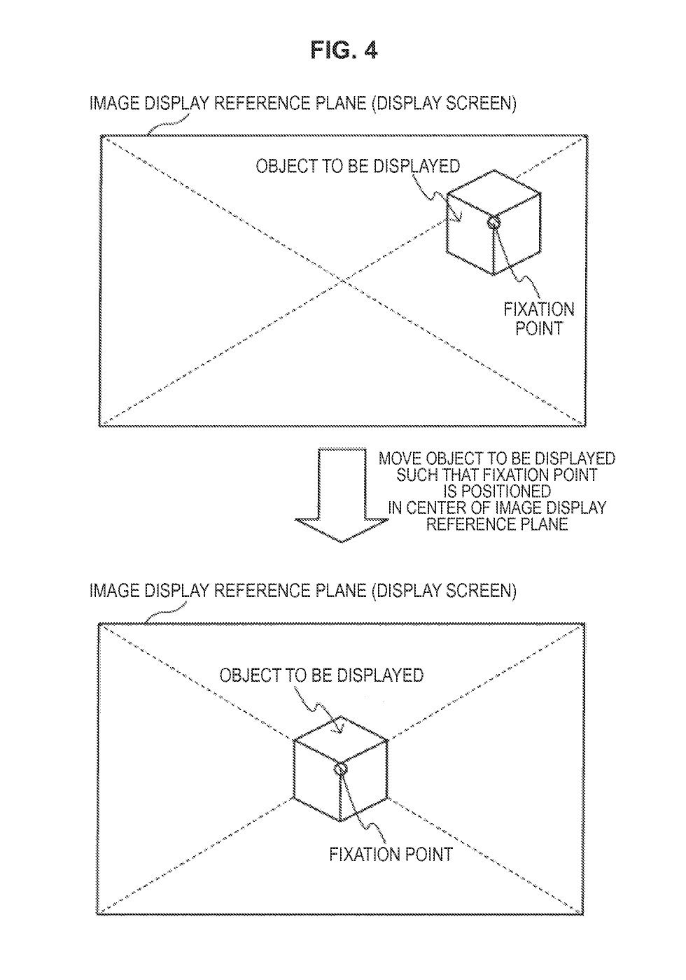

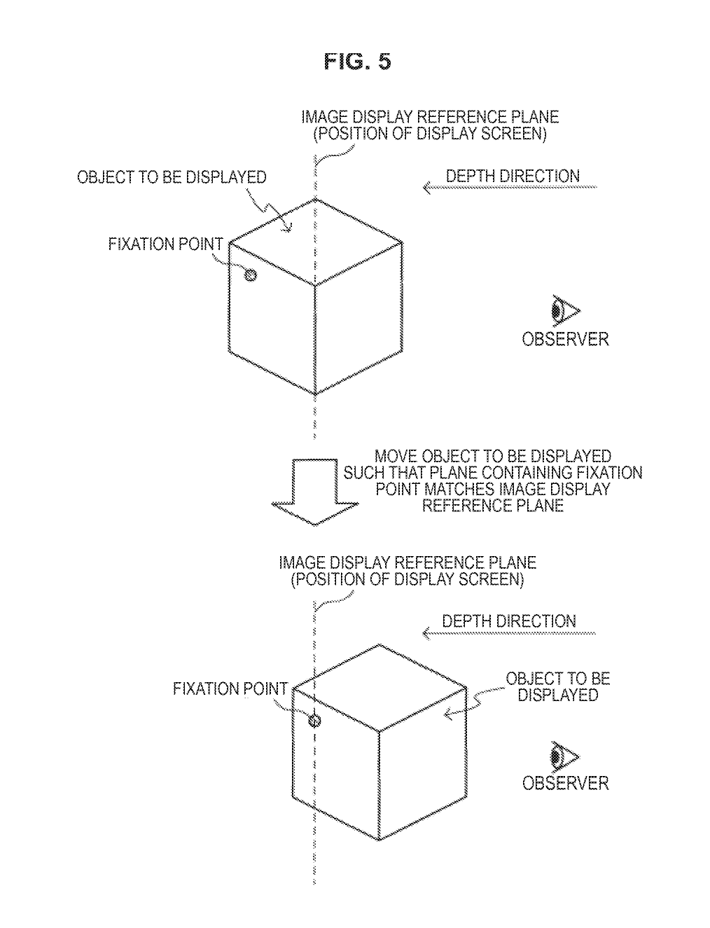

As shown, for example, in FIG. 4, the display controller 109 may move the object to be displayed in the image display reference plane so that the fixation point specified by the observer is positioned in the center of the image display reference plane based on information about the fixation point output by the fixation point identification unit 105. If, as shown, for example, in FIG. 5, the fixation point specified by the observer is not positioned in the image display reference plane, the display controller 109 may move the object to be displayed along the depth direction (in other words, the normal direction of the image display reference plane) so that the plane containing the specified fixation point matches image display reference plane. Accordingly, in the example shown, for example, in FIG. 5, the observer perceives the object to be displayed as if the object to be displayed that is displayed stereoscopically were coming closer to the observer.

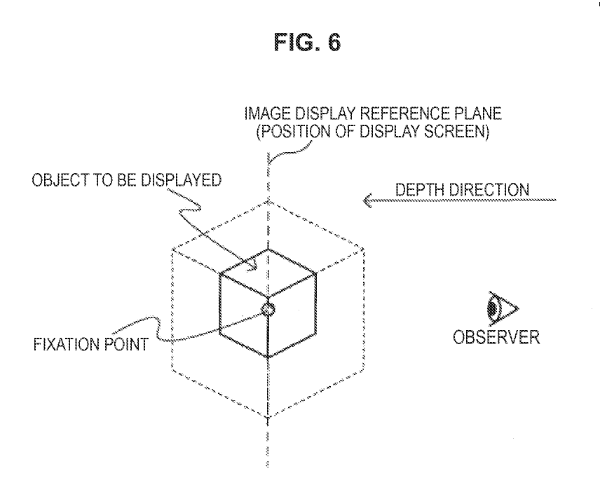

When, as shown, for example, in FIG. 6, scaling up processing or scaling down processing of an object to be displayed is performed in accordance with the user's operation, the display controller 109 can handle the selected fixation point as the origin of the scaling up/scaling down processing. Similarly, when rotation processing of an object to be displayed is performed in accordance with the user's operation, the display controller 109 may also handle the selected fixation point as the origin of the rotation processing.

A portion to be fixed by the observer can be made to be stereoscopically displayed in a natural state without the observer being tired by the above display control based on the fixation point being exercised by the display controller 109 and therefore, user's convenience can be enhanced. In addition, the area in which the observer can observe around the fixation point in a natural state without being tired can be maximized by the above display control based on the fixation point being exercised by the display controller 109.

The display controller 109 according to the present embodiment can exercise display control of not only the display apparatus such as a display provided in the information processing apparatus 10, but also various display apparatuses connected to the information processing apparatus 10 directly or via various networks. Accordingly, the display controller 109 according to the present embodiment can realize the aforementioned display control for display apparatuses provided outside the information processing apparatus 10.

In the foregoing, the display control processing performed by the display controller 109 according to the present embodiment has been described in detail with reference to FIGS. 3 to 6.

Returning to FIG. 2 again, the storage unit 111 included in the information processing apparatus 10 according to the present embodiment will be described.

The storage unit 111 is realized by, for example, a RAM, a storage device or the like. Object data displayed on the display screen is stored in the storage unit 111. The object data here includes, for example, any parts constituting a graphical user interface (GUI) such as icons, buttons, and thumbnails. In addition, various programs executed by the information processing apparatus 10 according to the present embodiment, various parameters that need to be stored while some kind of processing is performed, the progress of processing, or various databases may also be appropriately recorded in the storage unit 111. Further, various kinds of 3D image data used by the information processing apparatus 10 may be stored in the storage unit 111.

Each processing unit such as the user operation information acquisition unit 101, the display data acquisition unit 103, the fixation point identification unit 105, the fusional area identification unit 107, and the display controller 109 can freely access the storage unit 111 to write or read data.

In the foregoing, the configuration of the information processing apparatus 10 according to the present embodiment has been described in detail with reference to FIG. 2.

The functions of the user operation information acquisition unit 101, the display data acquisition unit 103, the fixation point identification unit 105, the fusional area identification unit 107, the display controller 109, and the storage unit 111 shown in FIG. 2 may be implemented in any kind of hardware if the hardware can mutually transmit and receive information via a network. In addition, processing performed by some processing unit may be realized by one piece of hardware or distributed processing of a plurality of pieces of hardware.

In the foregoing, an exemplary function of the information processing apparatus 10 according to the present embodiment has been shown. Each of the above structural elements may be formed by using general-purpose members or circuits or formed from hardware customized for the function of each structural element. Alternatively, the function of each structural element may all be executed by the CPU or the like. Therefore, components to be used can appropriately be changed in accordance with the technical level when the present embodiment is carried out.

A computer program to realize each function of the information processing apparatus according to the present embodiment as described above can be produced and implemented on a personal computer or the like. Also, a computer readable recording medium in which such a computer program is stored can be provided. The recording medium is, for example, a magnetic disk, optical disk, magneto-optical disk, flash memory or the like. In addition, the above computer program may be delivered via, for example, a network without using any recording medium.

<Flow of Information Processing Method>

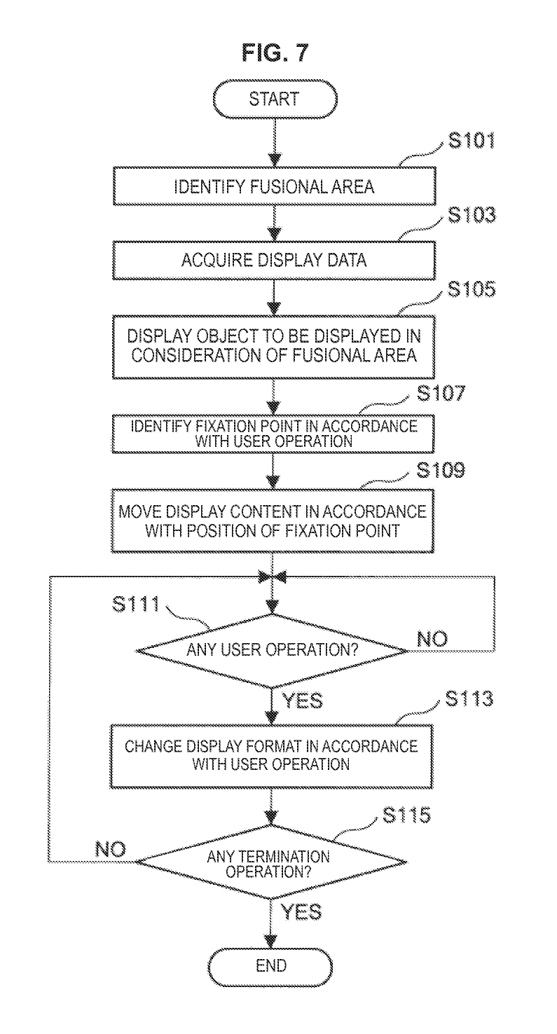

Subsequently, the flow of the information processing method executed by the information processing apparatus 10 according to the present embodiment will briefly be described with reference to FIG. 7.

In the information processing method according to the present embodiment, information about the fusional area of the observer is first identified by the fusional area identification unit 107 (step S101) and an identification result of the fusional area is output to the display controller 109.

Then, when the observer identifies 3D image data desired to be displayed by a user's operation, the user operation information acquisition unit 101 acquires the corresponding user operation information and outputs the user operation information to the display data acquisition unit 103. The display data acquisition unit 103 acquires display data based on the user operation information output by the user operation information acquisition unit 101 (step S103) and outputs the acquired display data (3D image data) to the display controller 109.

The display controller 109 uses the 3D image data output by the display data acquisition unit 103 and the information about the fusional area output by the fusional area identification unit 107 to display an object to be displayed corresponding to the display data (3D image data) in consideration of the fusional area (step S105). Accordingly, depending on whether an object to be displayed is present inside the fusional area, the display control is exercised in such a way that the display format of an object to be displayed present inside the fusional area and that of an object to be displayed present outside the fusional area are different.

Then, when the position specifying object such as a pointer, cursor or the like is operated by the user to perform an operation to identify the fixation point (for example, pressing a decision button or clicking on a mouse button), the corresponding user operation is acquired by the user operation information acquisition unit 101 and output to the fixation point identification unit 105. The fixation point identification unit 105 identifies the position specified by the user as the fixation point and (step S107) and outputs an identification result of the fixation point to the display controller 109.

Based on information about the fixation point output by the fixation point identification unit 105, the display controller 109 moves an object to be displayed such that the plane containing the specified fixation point becomes the image display reference plane or moves an object to be displayed in the plane such that the fixation point is positioned in the center of the image display reference plane (step S109).

Then, the information processing apparatus 10 waits and determines whether any user operation is performed (step S111). If a user operation is performed, the display controller 109 changes the display format by recalculating each viewpoint image in the stereoscopic display, moves an object to be displayed based on the position of the fixation point, or performs scaling up/scaling down processing using the fixation point as the origin in accordance with the user operation (step S113).

Then, the information processing apparatus 10 determines whether a termination operation of the stereoscopic display is performed (step S115). If no termination operation is performed, the information processing apparatus 10 returns to step S111 to wait for a user operation. On the other hand, if a termination operation is performed, the information processing apparatus 10 terminates the stereoscopic display processing of 3D image data.

The information processing apparatus 10 according to the present embodiment can prevent an object to be displayed from being perceived by the observer as double images by display control processing of the stereoscopic display based on the fusional area of the observer in the above flow being performed so that the quality of the stereoscopic display can be improved.

(Hardware Configuration)

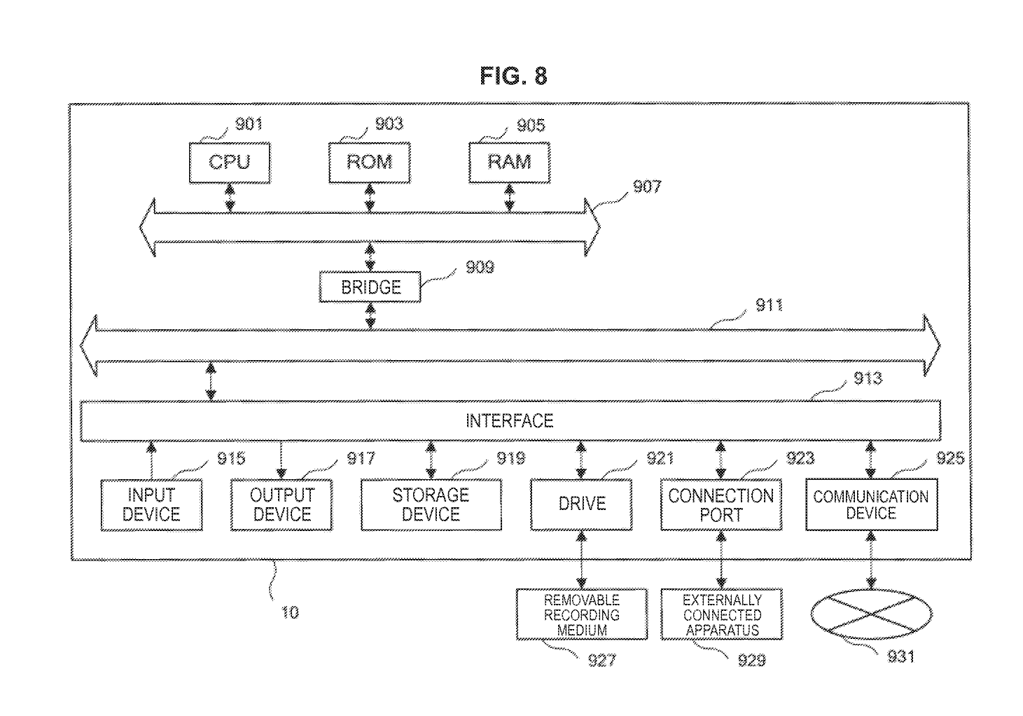

Next, the hardware configuration of the information processing apparatus 10 according to the embodiment of the present disclosure will be described in detail with reference to FIG. 8. FIG. 8 is a block diagram for illustrating the hardware configuration of the information processing apparatus 10 according to the embodiment of the present disclosure.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs that the CPU 901 uses and parameters and the like varying as appropriate during the execution of the programs. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected apparatus 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and directly provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication, or the like.

Heretofore, an example of the hardware configuration capable of realizing the functions of the information processing apparatus 10 according to the embodiment of the present disclosure has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

The preferred embodiment of the present disclosure has been described above in detail with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An information processing apparatus including:

a display controller that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

(2)

The information processing apparatus according to (1), wherein an area positioned outside the fusional area is an area away from an image display reference plane to a side of the observer exceeding a predetermined distance and an area away from the image display reference plane in a direction away from the observer exceeding the predetermined distance, the image display reference plane serving as a reference when the object to be displayed is displayed stereoscopically.

(3)

The information processing apparatus according to (2), wherein the display controller exercises display control such that a parallax of the object to be displayed positioned in the area away from the image display reference plane in the direction away from the observer exceeding the predetermined distance is fixed to the parallax in a boundary between the area away from the image display reference plane exceeding the predetermined distance and the fusional area.

(4)

The information processing apparatus according to (2) or (3), wherein the display controller exercises the display control such that the object to be displayed positioned in the area away from the image display reference plane to the side of the observer exceeding a predetermined distance is not displayed.

(5)

The information processing apparatus according to any one of (2) to (4), wherein the display controller adjusts a display position of the object to be displayed such that a fixation point selected by the observer is positioned in the image display reference plane.

(6)

The information processing apparatus according to (5), wherein the display controller adjusts the display position of the object to be displayed such that a position of the fixation point is positioned in a center of the image display reference plane.

(7)

The information processing apparatus according to (5) or (6), wherein the display controller adjusts the display position of the object to be displayed along a normal direction of the image display reference plane such that the fixation point is positioned in the image display reference plane.

(8)

The information processing apparatus according to any one of (5) to (7), wherein the display controller performs at least one of scaling up/scaling down processing and rotation processing of the object to be displayed using the fixation point as the reference.

(9)

An information processing method including:

controlling a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

(10)

A recording medium having a program stored therein, the program causing a computer to realize

a display control function that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

### REFERENCE SIGNS LIST

10 information processing apparatus
101 user operation information acquisition unit
103 display data acquisition unit
105 fixation point identification unit
107 fusional area identification unit
109 display controller
111 storage unit

1. An information processing apparatus comprising:
a display controller that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

2. The information processing apparatus according to claim 1, wherein an area positioned outside the fusional area is an area away from an image display reference plane to a side of the observer exceeding a predetermined distance and an area away from the image display reference plane in a direction away from the observer exceeding the predetermined distance, the image display reference plane serving as a reference when the object to be displayed is displayed stereoscopically.

3. The information processing apparatus according to claim 2, wherein the display controller exercises display control such that a parallax of the object to be displayed positioned in the area away from the image display reference plane in the direction away from the observer exceeding the predetermined distance is fixed to the parallax in a boundary between the area away from the image display reference plane exceeding the predetermined distance and the fusional area.

4. The information processing apparatus according to claim 3, wherein the display controller exercises the display control such that the object to be displayed positioned in the area away from the image display reference plane to the side of the observer exceeding a predetermined distance is not displayed.

5. The information processing apparatus according to claim 2, wherein the display controller adjusts a display position of the object to be displayed such that a fixation point selected by the observer is positioned in the image display reference plane.

6. The information processing apparatus according to claim 5, wherein the display controller adjusts the display position of the object to be displayed such that a position of the fixation point is positioned in a center of the image display reference plane.

7. The information processing apparatus according to claim 5, wherein the display controller adjusts the display position of the object to be displayed along a normal direction of the image display reference plane such that the fixation point is positioned in the image display reference plane.

8. The information processing apparatus according to claim 5, wherein the display controller performs at least one of scaling up/scaling down processing and rotation processing of the object to be displayed using the fixation point as the reference.

9. An information processing method comprising:
controlling a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.

10. A recording medium having a program stored therein, the program causing a computer to realize
a display control function that controls a display of an object to be displayed such that when the object to be displayed is displayed stereoscopically in accordance with 3D image data that can be displayed stereoscopically, a display format of the object to be displayed positioned outside a fusional area of an observer is different from a display format of the object to be displayed positioned inside the fusional area.
